(19) United States
(12) Patent Application Publication
(10) Pub. No.: US 2006/0196918 A1
(43) Pub. Date: Sep. 7, 2006

(54) Process for recovery heavy machines or machine components

(76) Inventor: Jose Francisco Lopes, Sumare (BR)

Correspondence Address: Christopher J. McDonald, Esq.;HOFFMAN, WASSON & GITLER, P.C., Suite 522, 2461 South Clark Street, Arlington, VA, 22202, US

(21) Appl. No.: 11/071,206

(22) Filed: Mar. 4, 2005

(51) Int. Cl. B23K 31/02

(52) U.S. Cl. 228/219

(57) ABSTRACT

The integrated recovery process uses an electrode or added metal chosen and prepared after an accurate analysis of the base metal including not only the composition of the base metal but the physical condition of the machine or component and the process through which the base metal has been obtained. Prior to welding, the machine or component to be recovered has initial surface cleaning to reveal not only the known failure but every area likely to fail in the future.

### FIELD OF THE INVENTION

The present invention relates to an integrated process for recovering machines and machine components having failure to cracks, fissures, dents or excessive wear.

### BACKGROUND OF THE INVENTION

Many machines have parts or whole components made of metallic material which are difficult to weld. Difficulty in welding may be due to high sensitivity to thermal-mechanical stress and susceptibility across crack formations during welding. Welding processes induce local heating and parts having complex shapes and high variations in cross-sectional areas are difficult to repair by welding. As a result, entire machines or entire components must be replaced. This leads to costs associated with not only the cost of the machine or component to be replaced, but also lost productivity due to downtime of the process utilizing the machine.

Some machines and components are recoverable by the use of a welding process. The welding process is preceded by a pre-heating treatment based on the base material temperature control and followed by a heat treatment for post welding stress relief. Heat treatments are both in furnace and on-site by means of resistences applied to the site of the damage covered by a thermal insulator layer. The welding electrode applies material to the damaged site with the material to be added chosen as appropriate to the base material of the component or machine.

Welding processes often induce deformation in the machine or process and are likely to create new failures, particularly by fracture, both in the recovered area and other areas. Such future fractures result from residual stress developed in the material due to the heat applied by the welding process and the use of an inappropriate material added to the damaged site.

The object of the invention is to eliminate or minimize internal stresses present in a machine or component after a recovery welding process.

It is another object of the invention to remove and repair any failure in a machine or component.

It is yet another object of the invention to ensure minimum post-recovery residual stress.

It is yet another object of the invention to provide a process for repairing and recovering machines and components minimizing the cost of the repair and the downtime in a process utilizing the machine.

These and other objects of the invention will become apparent for one of ordinary skill in the art after reviewing the disclosure of the invention.

### SUMMARY OF THE INVENTION

The integrated recovery process uses an electrode and added metal chosen and prepared after an accurate analysis of the base metal including not only the composition of the base metal but the physical condition of the machine or component and the process through which the base metal has been obtained. Prior to welding, the machine or component to be recovered has initial surface cleaning to reveal not only the known failure but every area likely to fail in the future.

### DETAILED DESCRIPTION OF THE INVENTION

Once a machine or component experiences failure, the area of failure is prepared and repaired by the process of the invention. Analysis is performed to determine the composition, physical condition and process used to form the component to be recovered. Initial surface cleaning reveals every flaw in the machine or part, in addition to the known failure. For purposes of this disclosure, the term component will encompass both a machine part and an entire machine. Non-destructive essays or a sampling is performed to identify every flaw. Once every flaw has been identified, superficial removal of dense and crushed areas begins. Cracks or fissures are opened with chamfers produced with mechanical means, such as chiseling. The removal and opening process occurs without introducing significant residual stresses.

After removal and opening is completed, reference points are established for dimension control during the welding process. Reference points are established according to the largest opening profile and the element main shafts. Reference points are created by welding pins on the reference ends. The element to be treated is hypothetically divided into areas with similar masses and to be as symmetrical as possible. For each area, a mass center is chosen. Thermal couples are applied to the mass center for effective control over temperature variations among different areas. Mass may be added to some areas to minimize the thermal inertia differences between the various areas.

Once complete, final positions of the element for welding are defined. Support is optimally isostatic but hyper static may also be used.

Resistences normal to specific heating surfaces for a welding process are distributed over the surface to be heated. The resistences are insulated with ceramic beads having fast coupling terminals on the ends to connect to high amperage cables. The amount of resistences to be applied on each area is related to its thermal inertia. After application of the resistences, the element is heat-insulated with a thermal insulator, such as 25 mm ceramic fiber layers for ideal insulation of 10° C./mm for typical stress relief temperatures. Windows are left in the element insulation where there are flaws to be corrected or it is bent. Pins for reference points extend through the insulating layer. Once insulated, heating is performed. For most metallurgical materials, heating up to 300° C. or less with a heating rate of a maximum of 150° C. per hour is conducted.

Heat treatment is applied to the element before welding to relieve stress acquired by the element throughout its operating life. Such heat treatment ensures an element free of pre-welding stress and having original resistance, resiliency and continuity properties. A thermal welding path is performed at the highest level possible, limited only by the hardness of the base metal depending on its physical-metallurgical structure. That level is at least the minimum stress relief temperature for the particular base metal.

The element dimensional condition is controlled with the reference pin during the welding process. Reference pins are monitored by a micro-metric screw system, comparing meters or other similar methods. Thermal control of areas is achieved by compatible thermal couples and power metric systems.

Every welding operation follows thermal framing in the following sequence:

(1) insulation opening through the corresponding window

(2) welding

(3) cleaning

(4) window closing

(5) thermal ballast establishment and dimensional checking.

The procedure is repeated as many times as is required.

The temperature level is maintained and monitored to relieve welding stress after the conclusion of welding. The cooling rate in each area at the end of the relief phase is controlled. When the element has reached 80° C., non-destructive essay sequences are started for the recovered areas. When the element reaches metrological room temperature, dimensions are confirmed and the establishment of the shop or field milling program for areas with added over metal. The process allows for excellent field and shop results and has fast, efficient, and low costs.

While the invention has been described with reference to a preferred embodiment, variations and modifications would be apparent to one of ordinary skill in the art without departing from the spirit of the invention. Such variations and modifications are within the scope of the invention.

1. A process for recovery of metal components, comprising
analyzing the component to determine the composition, physical condition and the process used to form the component
identifying all fractures in the component,
establishing reference points on the component,
applying thermocouples to said component,
insulating the component,
forming windows in the insulation over the fractures,
performing heat treatment on the component to relieve stresses in the component,
repairing the fractures with a welding operation,
closing the windows, and
allowing cooling of said component.

2. (canceled)

3. The process of claim 1, wherein identifying all fractures comprises initial surface cleaning.

4. The process of claim 1, wherein identifying all fractures comprises non-destructive essays.

5. The process of claim 1, further comprising
removal of dense and crushed areas from the component and opening fractures after identifying all fractures.

6. The process of claim 1, further comprising
establishing reference points,
dividing component into hypothetical areas,
choosing a mass center for each area, and
establishing a final position of the component.

7. The process of claim 6, wherein
establishing reference points comprises attaching pins to the component.

8. The process of claim 6, further comprising
monitoring the dimensional condition of the component during welding by monitoring the pins.

9. The process of claim 1, further comprising
insulating the component, the pins extending through the insulation.

10. The process of claim 1, further comprising
monitoring the dimensional condition of the component during welding.
